(19) United States
(12) Patent Application Publication
(10) Pub. No.: US 2007/0031620 A1
(43) Pub. Date: Feb. 8, 2007

(54) Smoke-permeable polyamide based food casing

(76) Inventors: Dirk Auf Der Heide, Alfhausen (DE); Christian Auf Der Heide, Osnabrueck (DE); Stefanie Stalberg, Taunusstein-Wehen (DE); Juerg-Heinrich Kallweit, Osnabrueck (DE)

Correspondence Address: ProPat;Klaus Schweitzer, 425-C South Sharon Amity Road, Charlotte, NC, 28211, US

(21) Appl. No.: 10/570,930

(22) PCT Filed: Sep. 22, 2004
(86) PCT No.: PCT/EP04/10645

§ 371 Date: Mar. 8, 2006

(30) Foreign Application Priority Data
Sep. 26, 2003 (DE) 10344867.5

(51) Int. Cl. A22C 13/00

(52) U.S. Cl. 428/34.8

(57) ABSTRACT

The invention relates to a tubular, single or multi-layered polyamide and/or copolyamide-based food casing and/or including a polyamide and/or copolyamide-based inner layer. The water-vapour permeability of the casing is less than 30 g/m² d. The surface tension of the inner side is greater than 28 dyne/cm², preferably 35-45 dyne/cm². The inside of the casing is impregnated with liquid smoke without the addition of a browning agent and the liquid smoke is practically totally absorbed by the casing. The casing is particularly useful as synthetic sausage skin, particularly for browing, cooking or roasting.

The invention relates to a liquid-smoke-impregnated, tubular, single-layer or multilayered food casing which is based on polyamide and/or copolyamide, or has an inner layer based on polyamide and/or copolyamide, and also to the use of the casing.

Cheese products and sausage products are smoked by the most varied methods to modify their flavor and color and at the same time to preserve them. In principle, there exists two different smoking methods for foods in a smoke-permeable casing, such as natural skin, textile skin, collagen skin, cellulose skin or cellulose-fiber skin. Firstly there is the smoking chamber method in which the food is smoked in a cloud of smoke. Secondly there is the liquid smoke method in which liquid smoke is sprayed on, or the product is dipped into liquid smoke. Both methods are relatively time consuming and thus costly. Exhaust air and exhaust water which contain smoke constituents must in addition be cleaned up in a costly manner. Foods in a smoke-permeable casing are, in addition, only storable for a short time. In the event of longer storage they dry out. Frequently they are often also infected by microorganisms. Such food products are therefore frequently provided with a water-vapor- and/or oxygen-impermeable second packaging. A second packaging, however, leads to further adverse accompanying phenomena. In the case of Fleischwurst, frequently drip loss is observed, in the case of Teewurst, the collection of fat below the second packaging (termed “fat loss”) is observed. There have therefore been numerous approaches to save the sausage manufacturer from having to perform separate smoking of the sausage by using presmoked food casings, and at the same time to optimize the quality of the food casing.

For this purpose, liquid-smoke-impregnated food casings were developed which are substantially impermeable to water vapor, and frequently also to atmospheric oxygen. Such a smoke-impregnated plastic barrier casing is disclosed in DE 101 24 581 A1. A mixture of liquid smoke and browning agent is applied to the inside. The mixture is to act on the inside for at least 5 days and is to be absorbed completely by the skin before it is shirred to form sticks. Particular preference is given to a three-layered casing with an outer layer and inner layer of polyamide and a middle barrier layer of polyethylene or ethylene/vinyl alcohol-copolymer. The casing absorbs only relatively little liquid smoke, and can therefore also only transfer a little smoke color to the food. To reinforce the color, the browning agent is also added.

DE-A 198 46 305 describes a barrier casing made of a plastic material which on the inside has a layer of an absorbent material (woven fabric or knitted fabrics) which is impregnated with dies or flavorings. During cooking or scalding, the dies or flavorings are transferred to the food enclosed by the casing. The inner layer is bonded to the adjacent layer of the casing generally by a glue. The barrier casing itself consists, for example, of polyamide and polyethylene layers. Tubular casings are generally produced from corresponding flat films by heat sealing or glueing. In the region of the sealing seam, the die or flavoring is frequently transferred unevenly. Also, sealed or glued casings frequently have an uneven shrinkage. Then, after scalding or cooking the sausage, an unwanted gel deposit between casing and sausage meat emulsion is observed in the seam regions.

The object therefore was still to provide a tubular food casing having barrier properties, which casing can absorb a sufficient amount of liquid smoke so that additional browning agent can be omitted. In addition, the casing is to be simply and rapidly producible, i.e. it is to allow final processing virtually immediately after impregnation with liquid smoke (i.e. in particular allowing shirring to form sticks).

The object was achieved using a single-layer or multilayered plastic barrier casing in which the inner layer (in contact with the food) is a layer based on polyamide and/or copolyamide. The surface tension of this layer is generally more than 28 dyn/cm². It is thus very readily wettable.

The invention thus relates to a liquid-smoke-impregnated, tubular, single-layer or multilayered food casing which is based on polyamide and/or copolyamide, or has an inner layer based on polyamide and/or copolyamide, the casing exhibiting a water vapor permeability less than 30 g/m² d, and the inside of the casing has a surface tension of greater than 28 dyn/cm² and the casing is impregnated on the inside with liquid smoke, but not with an additional browning agent.

The water vapor permeability of the liquid-smoke-impregnated casing is preferably 3 to 25 g/m² d (determined as specified in DIN 53 122, the casing being impinged from one side by air which has a temperature of 23° C. and a relative humidity of 85%).

The surface tension is preferably about 35 to 45 dyn/cm², particularly preferably about 40 dyn/cm². This has the effect that the liquid smoke can be applied particularly uniformly and homogeneously to the inside of the casing. To set the correct surface tension, the inside of the casing is if appropriate subjected to a corona treatment. This increases the surface tension and also the polarity of the inner surface of the casing. The casing or the polyamide inner layer of the casing has a swelling value of at least 5%, preferably 8 to 100%, particularly preferably about 10 to 75%, in each case at 23° C. The swelling has the effect that an amount of liquid smoke sufficient even for scalded-emulsion sausage or Teewurst can be absorbed by the casing and transferred to the sausage meat emulsion in the further processing. At a temperature of 21° C. it accordingly absorbs, in the preferred embodiment, about 8 to 100% water, based on the weight of the casing or the inner layer of the casing. This is equivalent, at a swelling value of 25%, to an application rate of about 20 to 30 g/m². The viscosity of the liquid smoke is also of importance. It is generally chosen to be such that the liquid smoke wets the inside of the casing uniformly without coalescing or forming drops. The single-layered casing or the PA inner layer of the multilayered casing generally has a relatively large thickness, so that it can absorb a sufficient amount of liquid smoke. The thickness in the case of the single-layered casings is about 20 to 130 μm. In the case of the multilayered casings, the thickness of the inner layer is generally about 15 to 70 μm.

An additional browning agent is not required and is accordingly also not present. The liquid smoke itself is preferably a natural liquid smoke, i.e. an acidic liquid smoke, because this is generally more color-intensive, and has a more natural flavor. However, a neutral or alkaline liquid smoke is also usable. The viscosity is set in a suitable manner by adding carboxymethylcellulose (CMC) or similar additives as required.

The polyamide or copolyamide (abbreviated as (co)polyamide) is preferably an aliphatic, in particular a linear aliphatic, (co)polyamide. This comprises, for example, nylon 6, nylon 6.6, nylon 6/6.6 (a polyblend or a random copolyamide of nylon 6 and nylon 6.6), nylon 4.6 (polytetramethylene adipamide), nylon 6.10, nylon 6.12 (a copolyamide of nylon 6 and nylon 12). Mixtures of various aliphatic (co)polyamides can also be used. Among the copolyamides are also included heterofunctional polyamides, in particular polyether amides, polyester amides, polyether ester amides and polyamide urethanes. Among these polymers, preference is then given to those having a block-like distribution. Particular preference is given to poly(ether block amides).

The polyamide is if appropriate blended with at least one partially aromatic (co)polyamide, such as nylon 6I/6T (a copolyamide based on hexamethylenediamine, isophthalic acid and terephthalic acid). The fraction of the partially aromatic copolyamide is expediently no more than 30% by weight, based on the weight of the single-layered casing or of the inner polyamide layer of the multilayered casing.

The casing or the inner PA layer of the casing can, in addition, comprise further constituents. These are in particular dies or color pigments, oxygen scavengers, UV absorbers, organic or inorganic fillers, thermoplasticized starch and/or water-soluble polymers, such as polyvinylalcohol or polyvinylpyrrolidone.

The further layers in the multilayered embodiment can consist of substantially any materials. Preferably layers are based on polyolefin, in particular polyethylene, polypropylene, polybutylene, LLDPE (linear low density polyethylene), ethylene/vinylalcohol copolymers or polyamide.

Between the individual layers, further thin (about 2 to 6 μm) adhesive layers may be situated. Highly suitable materials for the adhesive layer are, in particular, graft polymers, for example polyolefins, which are grafted with maleic anhydride, in addition also co- or terpolymers which in addition to ethylene and/or propylene units also comprise units having functional groups. The units having functional groups are, for example, (meth)acrylic acid, (meth)acrylic acid alkylesters or vinyl acetate. A suitable adhesion promoter is, in addition, rubber-modified polyethylene.

The number of layers is not limited in principle, but for practical reasons casings having no more than 5 layers, including any adhesion layers, are preferred. In addition, a symmetrical structure is expedient to keep the number of extruders required in production low. An advantageous structure of this type is, for example, polyamide/LLDPE/polyamide.

The inventive casing in a single-layered embodiment, as also in the multilayered embodiment, is generally biaxially stretched, generally also heat set or blown. The residual shrinkage in the oriented casings is generally no more than 20% in the longitudinal or transverse direction (determined after 20 minutes storage in water of 80° C.).

In the production of the inventive casing, known single-layered or multilayered plastic casings can be used. The inside is then impregnated, for example, by a liquid bubble which is maintained in a continuously newly formed loop of the casing (known as “slug coating”). Such a method is, moreover, also described in DE 101 24 581 A1 which is mentioned at the outset. Alternatively, the liquid bubble can also be maintained in position by pinching using a pinch-roll pair while the casing continues to move. The liquid smoke impregnation can even be performed directly before winding up. The insides of the casing which is laid flat surprisingly do not stick together. The casing can subsequently be further finely processed, i.e. for example shirred to form sticks, or divided into short sections which are then sealed at one end. The liquid smoke surprisingly does not form droplets on the inside. Generally, no more liquid smoke is applied than the casing can absorb. The foods produced using the inventive casing, in addition, exhibit a virtually homogeneous surface coloration, i.e. the liquid smoke has been uniformly applied. A time of action of the liquid smoke of at least 5 days, as described in the DE-A as essential, is not necessary. This observation was also unexpected by a person skilled in the art.

The inventive casing is, if appropriate, treated on its outside with a water-in-oil emulsion which comprises fungicides and/or preservatives. These are, for example, para-hydroxybenzoic acid esters, potassium sorbate, potassium propionate or propylene glycol. The oil component is, for example, a paraffin oil.

The inventive casing is used, in particular, as artificial sausage casing, especially for scalded-emulsion sausage (for example Fleischwurst) or raw sausage (for example Teewurst).

The examples below serve to illustrate the invention. Percentages herein are percentages by weight, unless stated otherwise or clear from the context. “pbw” stands for part(s) by weight.

### EXAMPLE 1

### Polyamide Monocasing

A seamless, blown-film casing based on polyamide 6.6 having a caliber of 40 mm and a wall thickness of 50 μm was, by means of a liquid bubble, charged internally with a natural liquid smoke which had a viscosity of 18 s (measured using the Ford4 cup). The pinching of the liquid bubble was set in such a manner that the inner surface of the casing was wetted by 23 g of liquid smoke per square meter. Immediately thereafter the casing was wound up again. It was then shirred and stuffed with Teewurst emulsion. Teewurst is a spreadable raw sausage. It was accordingly ripened for 3 days at 22° C. and 65% relative humidity. The weight loss after the ripening time was no more than 4 to 6%. After cleaning off the casing it was found that the surface of the Teewurst emulsion was uniformly and intensive colored and had the desired strong smoked flavor and the corresponding aroma.

### EXAMPLE 2

### Three-Layered Casing

A seamless, biaxially stretched and heat set 3-layered casing having a caliber of 45 mm which had a 22 to 27 μm thick layer of aliphatic polyamide (nylon 6) on the outside, an about 5 to 10 μm thick central layer of a mixture of a polyolefin (LLDPE) and an adhesion promoter (having maleic anhydride-grafted PE) and a 22 to 27 μm thick layer of a mixture of aliphatic polyamide (nylon 6) and a partially aromatic polyamide (nylon 6I/6T; mixing ratio 70:30 pbw) on the inside, was, by means of a liquid bubble, charged on the inside with a natural liquid smoke which had a viscosity of 15 s (measured using the Ford4 cup). The pinching of the liquid bubble was set in such a manner that the inner surface of the casing was wetted by 23 g of liquid smoke per square meter. Immediately subsequently the casing was wound up again. It was then shirred and stuffed with Fleischwurst emulsion. The Fleischwurst was scalded for 80 min at 78° C. and 100% relative humidity and subsequently cooled for 10 min at 10° C. and likewise 100% relative humidity. The sausage was then stored for 5 days. The weight loss after this storage time was no more than 0.5%. After peeling off the casing it was found that the surface of the sausage meat emulsion had been uniformly and intensively colored and had the desired typical smoked flavor and smoked aroma.

1. A liquid-smoke-impregnated, tubular, single-layer or multilayered food casing comprising a single-layer which is based on polyamide and/or copolyamide, or comprising an inner layer based on polyamide and/or copolyamide, the casing exhibiting a water vapor permeability of less than 30 g/m² d, and the inside of the casing having a surface tension of greater than 28 dyn/cm², wherein the casing is impregnated on the inside with liquid smoke, but not with an additional browning agent.

2. The food casing as claimed in claim 1, wherein the surface tension of the inside is 35 to 45 dyn/cm².

3. The food casing as claimed in claim 1, wherein the casing or the polyamide inner layer of the casing has a swelling value of at least 5% at 23° C.

4. The food casing as claimed in claim 1, wherein the water vapor permeability of said food casing is 3 to 25 g/m² d.

5. The food casing as claimed in 1, wherein said food casing is seamless.

6. The food casing as claimed in 1, wherein said food casing is biaxially oriented and heat set or blown.

7. The food casing as claimed in claim 6, wherein said food casing is biaxially oriented and has a residual shrinkage of less than 20% in the longitudinal and transverse directions.

8. The food casing as claimed in 1, wherein said food casing is corona-treated on the inside.

9. The food casing as claimed in 1, wherein the food casing is single-layered and the thickness of the single-layered casing is 20 to 130 μm.

10. The food casing as claimed in 1, wherein the food casing is multilayered and the thickness of the polyamide inner layer of the multilayered casing is 15 to 70 μm.

11. The use of the food casing as claimed in claim 1.

12. An artificial sausage casing as claimed in claim 11, wherein said artificial sausage casing is a scalded-emulsion sausage, cooked-meat sausage or raw sausage casing.
